(19) United States
(12) Patent Application Publication
(10) Pub. No.: US 2018/0048760 A1
(43) Pub. Date: Feb. 15, 2018

(54) METHOD AND DEVICE FOR INFORMATION EXCHANGE

(71) Applicant: ORA INC., BEIJING (CN)

(72) Inventors: YE ZHAO, BEIJING (CN); ZHONGYING GAO, BEIJING (CN); YINGWEI WAN, BEIJING (CN)

(21) Appl. No.: 15/792,728

(22) Filed: Oct. 24, 2017

Related U.S. Application Data
(63) Continuation of application No. PCT/CN2016/082179, filed on May 16, 2016.

(30) Foreign Application Priority Data
Jun. 9, 2015 (CN) 201510312725.9

(51) Int. Cl. H04M 3/42; G06F 3/0481; H04W 4/16; H04M 1/725; H04L 29/06; H04W 4/02

(52) U.S. Cl. CPC H04M 3/42; H04L 29/06176; H04W 4/02; H04W 4/16; H04M 1/7253; G06F 3/04812

(57) ABSTRACT

Disclosed are a method and a device for information exchange, where the method includes: selecting, from an information source set, at least two information sources; displaying the information sources on a same graphic interface; identifying an operation instruction of the graphic interface issued by a user; and transmitting information of the start information source to the target information source, and/or transmitting information of the target information source to the start information source. The embodiments of the application display the at least two information sources on the same graphic interface and implement the information exchange so that information can be shared between information sources. Compared with the related prior art, the application can be operated easily, and is capable of reducing repetitive operations, thereby avoiding an erroneous selection or omission of an information source.

### CROSS-REFERENCE TO RELATED APPLICATIONS

This application is a continuation of International Application No. PCT/CN2016/082179, filed on May 16, 2016, which claims priority to Chinese Patent Application No. 201510312725.9, filed on Jun. 9, 2015. The disclosures of the aforementioned applications are hereby incorporated by reference in their entireties.

### TECHNICAL FIELD

The embodiments of the present application relate to the field of information technology, and in particular to a method and a device for information exchange.

### BACKGROUND

With the development of information technology, visualized electronic equipment such as mobile phones and computers, which are the most common visualized electronic equipment, have become indispensable tools in daily life. Such electronic equipment have information exchange functions, such as sharing the information of a contact (for example, contact information) in the mobile phone contacts with another contact, or sharing relevant information of a friend, for example, his/her user's name, registration number on a social app/software installed on a mobile phone/computer with other friends.

The specific process of information exchange is: determining, by the user, the information source to be shared, such as a contact or a friend, clicking the share button, checking or clicking a target information source, such as other contacts in the mobile phone contacts or other friends on the social app/software, after selecting the target information source, clicking the send button, and then the information source to be shared is shared with the target information source.

In the prior art, when the number of the contacts in the mobile phone contacts or the friends in the social software is relatively large, the workload of repetitively checking or clicking target information sources would be heavy, which is prone to result in erroneous selections and/or omission of a target information source.

### SUMMARY

The embodiments of the present invention provide a method and a device for information exchange, which can be operated easily and capable of reducing repetitive operations, thereby avoiding an erroneous selection and omission of an information source.

An aspect of the embodiments of the present application provides a method for information exchange, including:

selecting, from an information source set, at least two information sources;

displaying the information sources on a same graphic interface;

identifying an operation instruction of the graphic interface issued by a user, where the operation instruction is configured to instruct two exchanging parties of the information sources to implement information exchange, and the two exchanging parties includes a start information source and a target information source;

and transmitting information of the start information source to the target information source, and/or transmitting information of the target information source to the start information source.

Another aspect of the embodiments the of the present application provides a device for information exchange, including:

a selecting module, configured to select, from an information source set, at least two information sources;

a graphic interface displaying module, configured to display the information sources on a same graphic interface;

an identifying module, configured to identify an operation instruction of the graphic interface issued by a user, where the operation instruction is configured to instruct two exchanging parties of the information sources to implement information exchange, and the two exchanging parties include a start information source and a target information source;

a transmitting module, configured to transmit information of the start information source to the target information source, and/or transmit information of the target information source to the start information source.

The method and device for information exchange provided by the embodiments of the present application display at least two information sources on a same graphic interface, and implement the information exchange according to the operation instruction of the graphic interface issued by the user, that is, the user utilizes a visualized graphic interface to operate the information sources so that information can be shared therebetween, Compared with the related prior art involving a repetitive checking or clicking on information sources, the application can be operated easily, and is capable of reducing repetitive operations, thereby avoiding an erroneous selection or omission of an information source.

### BRIEF DESCRIPTION OF DRAWINGS

FIG. 1 is a flowchart of a method for information exchange according to one embodiment of the present application;

FIG. 2 is a schematic diagram of a graphic interface provided according to another embodiment of the present application;

FIG. 3 is a schematic diagram of a graphic interface according to another embodiment of the present application;

FIG. 4 is a schematic diagram of a graphic interface according to another embodiment of the present application;

FIG. 5 is a schematic diagram of a graphic interface according to another embodiment of the present application;

FIG. 6 is a schematic diagram of a graphic interface according to another embodiment of the present application;

FIG. 7 is a schematic diagram of a graphic interface according to another embodiment of the present application;

FIG. 8 is a structural diagram of a device for information exchange according to an embodiment of the present application.

### DESCRIPTION OF EMBODIMENTS

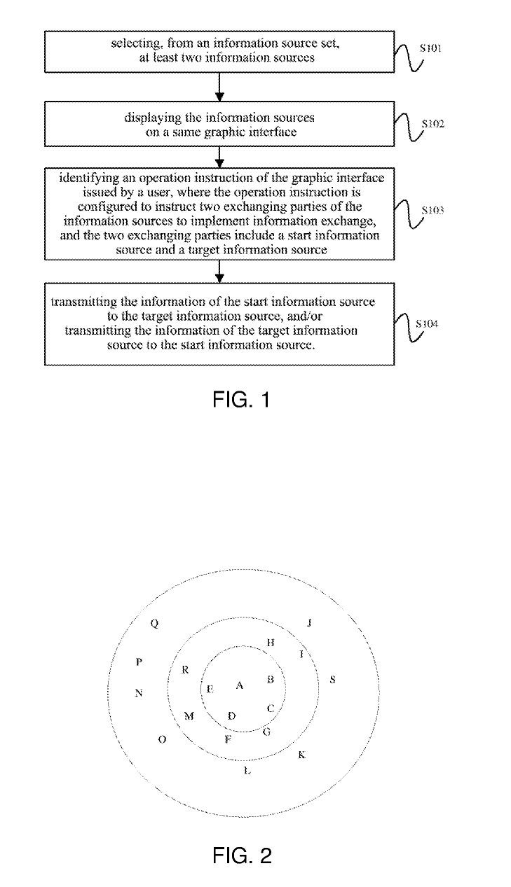

FIG. 1 is a flowchart of a method for information exchange provided by an embodiment of the present application. The device for implementing the method for information exchange has a visualized operation area, that is to say, the device for implementing the method for information exchange is a visualized device, which is not limited to a computer, a television, a mobile phone, a camera, a video camera, a portable android device (PAD), a personal digital assistant (PDA), a game machine, an audio/video equipment, a watch, a hand ring, a displayable card, a pair of visual glasses, a cinematograph, a projector, etc. Aiming at the disadvantage of a repetitive checking or clicking on information sources involving in the prior art, which is prone to result in erroneous selections or omission of an information source, the embodiments of the present application provide a method for information exchange with the following specific steps:

Step S101: selecting, from an information source set, at least two information sources;

In the embodiments of the present application, the information source set refers to a carrier that carries or is connected with information, for example, mobile phone contacts, a card album, wechat friends, QQ friends, a resume set, an email address set, an app set and a game set, while an information source refers to an individual member in the information source set. The visualized device that implements the method for information exchange stores the information source set, and selects at least two information sources from an information source set. The method for selecting information sources may be according to a preset rule or the user's selections.

Step S102: displaying the information sources on a same graphic interface;

The visualized device displays the selected information sources on a same graphic interface, so that the user may see the information sources selected by the visualized device according to the preset rule or the user's selections.

Step S103: identifying an operation instruction of the graphic interface issued by a user, where the operation instruction is configured to instruct two exchanging parties of the information sources to implement information exchange, and the two exchanging parties include a start information source and a target information source;

The user operates the information sources in the graphic interface, the operation is not limited to touching, dragging, connecting, covering, capturing gesture, shaking, voice recognition, etc. The visualized device identifies the operation instructions generated by the user's operation. The operation instructions include the information sources, i.e., the two parties of information exchange, including the start information source and the target information source on which information exchange is to be performed, and instruct two exchanging parties of the information sources to implement information exchange.

Step S104: transmitting the information of start information source in the information sources on which information exchange is performed to the target information source, and/or transmitting the information of the target information source to the start information source.

The information sources on which information exchange is performed are the two parties of the information exchange including the shared information source, i.e. the start information source, and the target information source which is the information source to receive the shared information. The user terminal transmits the information of the start information source to the target information source and/or transmits the information of the target information source to the start information source, i.e., the exchange of information between the start information source and the target information source is implemented by the visualized device.

The embodiment of the present application displays the at least two information sources on a same graphic interface, and implements the information exchange according to the operation instruction of the information sources of the graphic interface issued by the user, that is, the user controls the information sources by utilizing a visualized graphic interface so that information can be shared between the information sources. Compared with the related prior art involving a repetitive checking or clicking on information sources, the application can be operated easily, and is capable of reducing repetitive operations, thereby avoiding an erroneous selection or omission of an information source.

FIG. 2 is a schematic diagram of a graphic interface provided by another embodiment of the present application. On the basis of the above-described embodiment, the selecting at least two information sources from an information source set comprising: calculating a first distance between two terminals corresponding to any two information sources according to position information of terminals corresponding to respective information sources in the information source set, selecting an information source with the first distance smaller than or equal to a first preset distance; or calculating a second distance between a terminal corresponding to any information source in the information source set and a terminal of the user according to position information of terminals corresponding to respective information sources in the information source set, selecting an information source with the second distance smaller than or equal to a second preset distance; or selecting at least two information sources that are established within a preset time range according to information of establishment time of respective information sources in the information source set; or selecting at least two information sources whose respective communication frequency with the a terminal of the user is greater than or equal to a preset communication frequency according to communication frequencies of respective information sources with the terminal of the user in the information source set; or selecting at least two information sources belonging to a same group in the information source set.

For example, the visualized device is a mobile phone, and the information source set is the mobile phone contacts storing all of the user's contacts. In order to implement the information exchange of part of the contacts in the mobile phone contacts, it is necessary to select part of contacts from the mobile phone contacts first, that is to say, to select information sources from the information source set, and the visualized device may select the information sources from the information source set according to a preset rule.

For example, selecting all the contacts within a range of the first preset distance from the mobile phone contacts based on the Global Positioning System (GPS), so that information can be shared with the contacts within the range of the first preset distance; or selecting, from the mobile phone contacts, all the contacts within a range of the second preset distance from the local users, so that information can be shared with the contacts within the second preset distance; or selecting, from the mobile phone contacts, all the contacts that were established within a preset time range, so that the local user may share information with contacts established within a preset time range; or selecting, from the mobile phone contacts, all the contacts whose communication frequency with the local user's terminal is greater than or equal to a preset communication frequency, where specifically the communication frequency is the number of communications or how frequent the communication is; or grouping the contacts in advance, for example, there are a friend group, a relative group, a colleague group and so on and selecting contacts in any one of the groups. The embodiments of the present application are not limited to the above-described preset rule, and any possible implementation that can select information sources from the information source set is within the protection scope of the present application.

The at least two information sources are information sources randomly selected by the user. Moreover, the information sources selected by the visualized device from the information source set may also be information sources randomly selected by the user.

The displaying the information sources on a same graphic interface includes: displaying the identification information of the information sources on a same graphic interface.

The visualized device displays the selected information sources on the graphic interface as identification information in a unified manner. As shown in FIG. 2, A represents the local user, and B-S represent information sources selected from the information source set by the visualized device, where A-S are displayed on the graphic interface as identification information in a unified manner. For example, A-S represent mobile phone number, headshot, location, ID number and so on in a unified manner.

As shown in FIG. 2, it is assumed that selecting information sources from information source set by the visualized device is implemented based on a preset rule, where the information sources are within a second preset distance from the user according to the preset rule, and B-S specifically represent the contacts within the second preset distance from the local user A in the mobile phone contacts, where B, C, D and E are the nearest contacts to A, then Q, P, N, O, R, M, F, G, H, and I are the nearer contacts, while L, K, S, and J are the farthest contacts from A.

As shown in FIG. 2, it is assumed that selecting information sources from information source set by the visualized device is implemented based on the user's selections, where B-S specifically represent contacts selected from the mobile phone contacts by local user A.

In the embodiments of the present application, the visualized device selects the information sources from the information source set through the preset rule, which improves the convenience for selecting the information sources.

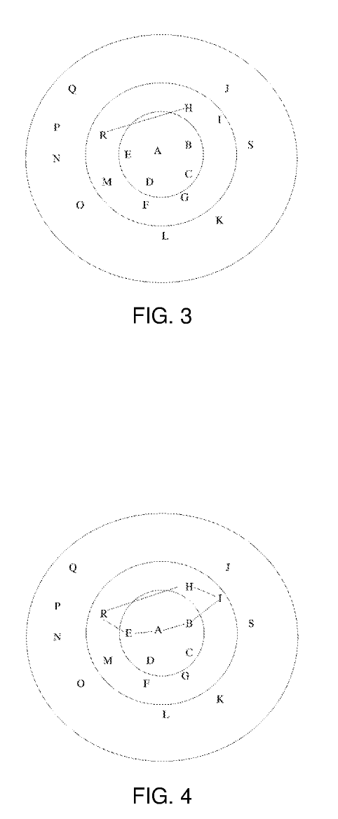

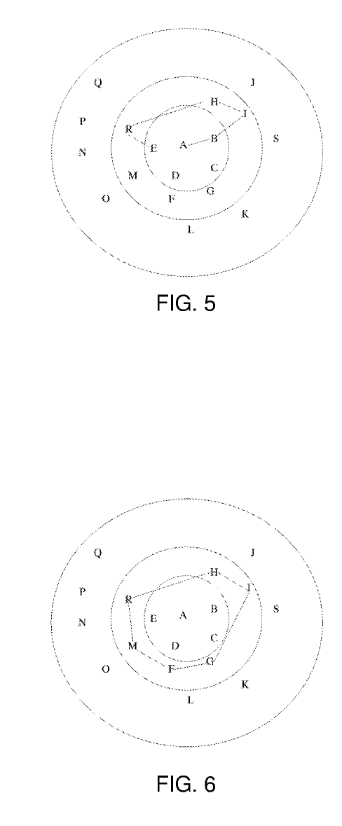

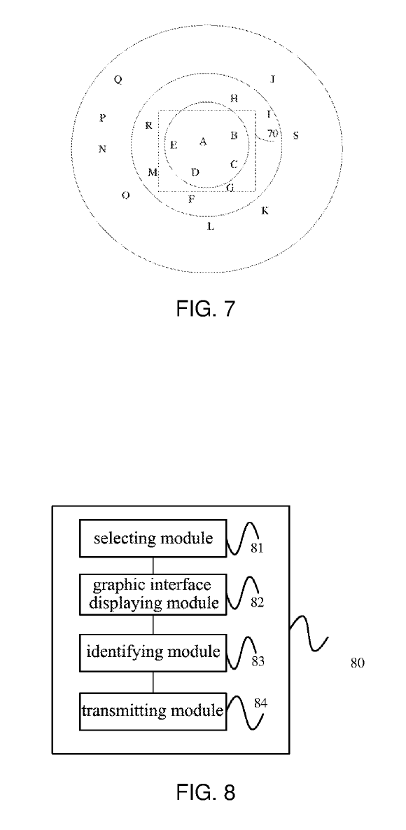

FIG. 3 is a schematic diagram of a graphic interface provided by another embodiment of the present application; FIG. 4 is a schematic diagram of a graphic interface provided by yet another embodiment of the present application; FIG. 5 is a schematic diagram of a graphic interface provided by yet another embodiment of the present application; FIG. 6 is a schematic diagram of a graphic interface provided by yet another embodiment of the present application; FIG. 7 is a schematic diagram of a graphic interface provided by yet another embodiment of the present application. On the basis of the above-described embodiment, the start information source is the start point of user's single operation, and the target information source is the end point of user's single operation; or the start information source is any one of the multiple information sources operated by the user, and the target information source is the information source other than the start information source among the multiple information sources operated by the user; or the start information source is any information source within a closed connection line formed by multiple information sources operated by the user, and the target information source is the information source other than the start information source within the closed connection line; or the start information source is any one of information sources in a sub-area of the graphic interface set by the user's operation, and the target information source is the information source other than the start information source in the sub-area of the graphic interface.

As shown in FIG. 3, on the basis of FIG. 2, the information sources in graphic interface are operated by the user, for example, when a connection between R and H is established by the user, R and H are the target information sources, and then the visualized device shares the contact information of R with H and simultaneously shares the contact information of H with R based on the connection between R and H, thus the information sharing or information exchange between R and H is implemented. The visualized device may also share the contact information of R with W based on the connection between R and H without sharing the contact information of H with R, thus the unidirectional sharing is implemented. In the embodiments of the present application, one same operation executed by the user may lead to different execution results, but one operation at a time can only lead to one corresponding execution result, and which execution result is to be executed may be determined by setting different resolution modes in the visualized device. Moreover, the connection between the two information sources not only can be determined as bidirectional sharing or unidirectional sharing, but also can be determined as other sharing manners which will not be limited here.

As shown in FIG. 4, the information sources are operated by the user through the graphic interface, for example, when a closed line is formed by A, B, I, H, R and E, A, B, I, H, R and E are the target information sources, and the visualized device shares any one of the information sources of A, B, I, H, R and E with other information sources based on the closed line formed by A, B, I, H, R and E, so that the information sharing or information exchange between any two information sources of A, B, I, H, R and E is implemented.

As shown in FIG. 5, the information sources are operated by the user through the graphic interface, for example, when a non-closed line is formed by A, B, I, H, R and E, then A, B, I, H, R and E are the target information sources, and the visualized device shares the information source of A with B, shares the information source of B with I, shares the information source of I with H, shares the information source of H with R, shares the information source of R with E based on the non-closed line formed by A, B, I, H, R and E, thus the information sharing between A, B, I, H, R and E is implemented in a unidirectional manner in the order of A, B, I, H, R, E, similarly, the information sharing between E, R, H, I, B and A is implemented in a unidirectional manner in the order of E, R, H, I, B and A.

As shown in FIG. 6, the information sources are operated by the user through the graphic interface, for example, when a closed line is formed by F, G, I, H, R and M within which A, B, C, D and E are included, the visualized device shares any one of the information sources of A, B, C, D and E with the other information sources, so that the information sharing or information exchange between any two information sources of A, B, C, D and E are implemented; or the visualized device shares any one of the information sources of F, G, I, H, R, M, A, B, C, D and E with the other information sources, so that the information sharing or information exchange between any two information sources of F, G, I, H, R, M, A, B, C, D and E is implemented.

As shown in FIG. 7, the information sources are operated by the user through the graphic interface, for example, A, B, C, D, E and G are set in the area 70, the visualized device share any one of the information sources of A, B, C, D, E and G in the area 70 with the other information source in the area 70, so that the information sharing or information exchange between any two information sources of A, B, C, D, E and G is implemented.

The embodiments of the present application are not limited to the above-described information sharing manners as shown in FIGS. 3-7.

In the embodiment of the present application, the visualized device implements different ways for information exchange according to different operation instructions of information sources of the graphic interface issued by the user, which provides different ways to implement information exchange through graphic interface and improves the diversity of ways for information exchange.

FIG. 8 is a structural diagram of a device for information exchange provided by one embodiment of the present application. The device for information exchange provided by the embodiments of the present application may implement the processing flow provided by the embodiments of the method for information exchange. As shown in FIG. 8, the device for information exchange 80 includes a selecting module 81, a graphic interface displaying module 82, an identifying module 83 and a transmitting module 84, where the selecting module 81 is configured to select, from an information source set, at least two information sources; the graphic interface displaying module 82 is configured to display the information sources on a same graphic interface; the identifying module 83 is configured to identify an operation instruction of the graphic interface issued by a user; the operation instruction is configured to instruct two exchanging parties of the information sources to implement information exchange, the two exchanging parties including a start information source and a target information source; the transmitting module 84 is configured to transmit information of the start information source to the target information source, and/or transmit information of the target information source to the start information source.

The embodiments of the application displays the at least two information sources on the same graphic interface, and implement the information exchange according to the operation instruction on the information source of the graphic interface issued by the user, that is, the user control the information sources through a visualized graphic interface so that information can be shared between information sources. Compared with the related prior art involving a repetitive checking or clicking on information sources, the application can be operated easily, and is capable of reducing repetitive operations, thereby avoiding an erroneous selection or omission of an information source.

On the basis of the above-described embodiment, selecting module 81 is specifically configured to calculate a first distance between two terminals corresponding to any two information sources according to position information of terminals corresponding to respective information sources in the information source set, selecting an information source with the first distance smaller than or equal to a first preset distance; or calculate a second distance between a terminal corresponding to any information source in the information source set and a terminal of the user according to position information of terminals corresponding to respective information sources in the information source set, selecting an information source with the second distance smaller than or equal to a second preset distance; or select at least two information sources that are established within a preset time range according to information of establishment time of respective information sources in the information source set; or select at least two information sources whose respective communication frequency with the a terminal of the user is greater than or equal to a preset communication frequency according to communication frequencies of respective information sources with the terminal of the user in the information source set; or select at least two information sources belonging to a same group in the information source set.

The at least two information sources are information sources randomly selected by the user.

The graphic interface displaying module 82 is specifically configured to display identification information of the information sources on a same graphic interface.

The start information source is the start point of the user's operation, and the target information source is the end point of the user's operation; or the start information source is any one of the multiple information sources operated by the user, and the target information source is the information source other than the start information source among the multiple information sources operated by the user; or the start information source is any information source within a closed connection line formed by multiple information sources operated by the user, and the target information source is the information source other than the start information source within the closed connection line; or the start information source is any one of information sources in a sub-area of the graphic interface set by the user's operation, and the target information source is the information source other than the start information source in the sub-area of the graphic interface.

The visualized device provided by the embodiments of the present application may be specifically configured to implement the method embodiment provide by FIG. 1, and the specific function thereof will not be repeated here.

In the embodiments of the present application, the visualized device selects information sources from the information source set according to a preset rule, which improves the convenience for selecting the information sources; the visualized device further implements different ways for information exchange according to different operation instructions of the information sources of the graphic interface issued by the user, which provides different ways to implement information exchange through graphic interface and improves the diversity of ways for information exchange.

In conclusion, The embodiments of the application display the at least two information sources on the same graphic interface, and implement the information exchange according to the operation instruction of the information sources of the graphic interface issued by the user, that is, the user controls the information sources by a visualized graphic interface so that information can be shared between information sources. Compared with the related prior art involving a repetitive checking or clicking on information sources, the application can be operated easily, and is capable of reducing repetitive operations, thereby avoiding an erroneous selection or omission of an information source; the visualized device selects the information sources from the information source set according to the preset rule, which improves the convenience for selecting the information sources; the visualized device further implements different ways for information exchange according to different operation instructions of information sources of the graphic interface issued by the user, which provides different ways to implement information exchange through graphic interface and improves the diversity of ways for information exchange.

In several embodiments provided by the present application, it is to be understood that the disclosed apparatus and method may be implemented in other ways. For example, the embodiments of the device described above are merely illustrative, for example, the division of the units is only a division of logical function, and there may be additional ways when actually implemented, for example, multiple units or components may be combined or may be integrated into another system, or some features can be ignored, or not executed. Moreover, the coupling or direct coupling or communicative connection shown or discussed may be a indirect coupling, or a communicative connection through some interfaces, devices or units, which may be electrical, mechanical, or otherwise.

The units described as the separated components may or may not be physically separate, and the components shown as units may or may not be physical units, that is to say, they may be located in one place or may be distributed over a plurality of network elements. The part or all of the elements may be selected according to actual needs to achieve the object of the present embodiment.

In addition, each of the functional units provided by the various embodiments of the present application may be integrated in one processing unit, or may physically and separately exist, besides, two or more units may be integrated in one unit. And the above integrated units may be implemented in a form of hardware or a form of hardware and software functional unit.

The above-mentioned integrated unit implemented in the form of software functional unit may be stored in a computer readable medium. The above software functional unit is stored in a storing medium, including a number of instructions to cause a computer device (which may be a PC, or a server, or a network device) or a processor to execute some steps in the methods provided by various embodiments of the present application. And the aforementioned storage medium includes a variety of media such as a USB disk, a mobile hard disk, a read-only memory (ROM), a random access memory (RAM), a magnetic disk, an optical disk or the like.

It will be apparent to those skilled in the art that the division of functional modules is merely exemplified for the convenience and simplicity of the description. In practical application, the above functions may be distributed and implemented by different functional modules as needed, that is, the internal structure of the apparatus is divided into different functional modules to complete all or part of the functions described above. As to the specific operation process of the above described apparatus will not be repeated here, since reference can be made to the corresponding process in the above method embodiment.

Finally, it should be noted that the above embodiments are merely used to be illustrative of the technical solutions of the present application and are not intended to be limiting thereof. Although the application has been described in detail with reference to the foregoing embodiments, it will be understood by those of ordinary skill in the art that it is still possible to modify the technical solutions described in the foregoing embodiments or to equivalently replace some or all of the technical features therein, and these modifications or substitutions do not make the essence of corresponding technical solution depart from the scope of the embodiments of the present application.

What is claimed is:

1. A method for information exchange, comprising:
selecting, from an information source set, at least two information sources;
displaying the information sources on a same graphic interface;
identifying an operation instruction of the graphic interface issued by a user, wherein the operation instruction is configured to instruct two exchanging parties of the information sources to implement an information exchange, and the two exchanging parties comprise a start information source and a target information source; and
transmitting information of the start information source to the target information source, and/or transmitting information of the target information source to the start information source.

2. The method according to claim 1, wherein the selecting, from an information source set, at least two information sources comprises:
calculating a first distance between two terminals corresponding to any two information sources according to position information of terminals corresponding to respective information sources in the information source set, and selecting an information source with the first distance smaller than or equal to a first preset distance; or
calculating a second distance between a terminal corresponding to any information source in the information source set and a terminal of the user according to position information of terminals corresponding to respective information sources in the information source set, and selecting an information source with the second distance smaller than or equal to a second preset distance; or
selecting at least two information sources that are established within a preset time range according to information of establishment time of respective information sources in the information source set; or
selecting at least two information sources whose respective communication frequency with a terminal of the user is greater than or equal to a preset communication frequency according to communication frequencies of respective information sources with the terminal of the user in the information source set; or
selecting at least two information sources belonging to a same group in the information source set.

3. The method according to claim 1, wherein the at least two information sources are information sources randomly selected by the user.

4. The method according to claim 2, wherein the displaying the information sources on a same graphic interface comprises:
displaying identification information of the information sources on a same graphic interface.

5. The method according to claim 3, wherein the displaying the information sources on a same graphic interface comprises:
displaying identification information of the information sources on a same graphic interface.

6. The method according to claim 4, wherein the start information source is a start point of a single operation of the user, and the target information source is an end point of the single operation of the user; or
the start information source is any one of multiple information sources operated by the user, and the target information source is an information source other than the start information source among the multiple information sources operated by the user; or
the start information source is any information source within a closed connection line formed by multiple information sources operated by the user, and the target information source is an information source other than the start information source within the closed connection line; or
the start information source is any one of information sources in a sub-area of a graphic interface set by an operation of the user, and the target information source is an information source other than the start information source in a sub-area of the graphic interface.

7. The method according to claim 5, wherein the start information source is a start point of a single operation of the user, and the target information source is an end point of the single operation of the user; or
the start information source is any one of multiple information sources operated by the user, and the target information source is an information source other than the start information source among the multiple information sources operated by the user; or
the start information source is any information source within a closed connection line formed by multiple information sources operated by the user, and the target information source is an information source other than the start information source within the closed connection line; or
the start information source is any one of information sources in a sub-area of a graphic interface set by an operation of the user, and the target information source is an information source other than the start information source in a sub-area of the graphic interface.

8. A device for information exchange, comprising:
a selecting module, configured to select, from an information source set, at least two information sources;
a graphic interface displaying module, configured to display the information sources on a same graphic interface;
an identifying module, configured to identify an operation instruction of the graphic interface issued by a user, wherein the operation instruction is configured to instruct two exchanging parties of the information sources to implement an information exchange, and the two exchanging parties comprise a start information source and a target information source;
a transmitting module, configured to transmit information of the start information source to the target information source, and/or transmitting information of the target information source to the start information source.

9. The device for information exchange according to claim 8, wherein the selecting module is specifically configured to calculate a first distance between two terminals corresponding to any two information sources according to position information of terminals corresponding to respective information sources in the information source set, and select an information source with the first distance smaller than or equal to a first preset distance; or
calculate a second distance between a terminal corresponding to any information source in the information source set and a terminal of the user according to position information of terminals corresponding to respective information sources in the information source set, and select an information source with the second distance smaller than or equal to a second preset distance; or
select at least two information sources that are established within a preset time range according to information of establishment time of respective information sources in the information source set; or
select at least two information sources whose respective communication frequency with a terminal of the user is greater than or equal to a preset communication frequency according to communication frequencies of respective information sources with the terminal of the user in the information source set; or
select at least two information sources belonging to a same group in the information source set.

10. The device for information exchange according to claim 9, wherein the at least two information sources is information sources randomly selected by the user.

11. The device for information exchange according to claim 9 wherein the graphic interface displaying module is specifically configured to display identification information of the information sources on a same graphic interface.

12. The device for information exchange according to claim 10 wherein the graphic interface displaying module is specifically configured to display identification information of the information sources on a same graphic interface.

13. The device for information exchange according to claim 11, wherein the start information source is a start point of a single operation of the user, and the target information source is an end point of the single operation of the user; or
the start information source is any one of multiple information sources operated by the user, and the target information source is an information source other than the start information source among the multiple information sources operated by the user; or
the start information source is any information source within a closed connection line formed by multiple information sources operated by the user, and the target information source is an information source other than the start information source within the closed connection line; or
the start information source is any one of information sources in a sub-area of a graphic interface set by an operation of the user, and the target information source is an information source other than the start information source in a sub-area of the graphic interface.

14. The device for information exchange according to claim 12, wherein the start information source is a start point of a single operation of the user, and the target information source is an end point of the single operation of the user; or
the start information source is any one of multiple information sources operated by the user, and the target information source is an information source other than the start information source among the multiple information sources operated by the user; or
the start information source is any information source within a closed connection line formed by multiple information sources operated by the user, and the target information source is an information source other than the start information source within the closed connection line; or
the start information source is any one of information sources in a sub-area of a graphic interface set by an operation of the user, and the target information source is an information source other than the start information source in a sub-area of the graphic interface.
